(19) United States
(12) Patent Application Publication
(10) Pub. No.: US 2007/0290916 A1
(43) Pub. Date: Dec. 20, 2007

(54) Method of Detecting Physical Phenomena

(75) Inventor: Eran Ofek, Modi'in (IL)

Correspondence Address: EDWARD S. SHERMAN, ESQ., 3554 ROUND BARN BLVD., SUITE 303, SANTA ROSA, CA, 95403, US

(73) Assignee: PHYSICAL LOGIC AG, Zug (CH)

(21) Appl. No.: 11/762,706

(22) Filed: Jun. 13, 2007

Related U.S. Application Data
(60) Provisional application No. 60/804,990, filed on Jun. 16, 2006.

(51) Int. Cl. G01S 7/36; H04Q 5/22; G01S 13/78; G08B 13/14

(52) U.S. Cl. 342/19; 342/45; 340/572.1; 340/10.1

(57) ABSTRACT

A method is provided for more accurate and reliable sensing of phenomena that are potentially obscured by noise, spoofing or jamming, that is deliberate attempts to obscure the phenomena by false signals or noise in response to the stimuli being provided and/or a detector being activated. The method deploys an array of emitter and detectors that are programmed to interrogate the selected environment at quasi-random intervals

### CROSS REFERENCE TO RELATED APPLICATIONS

The present application claims priority to the U.S. Provisional Patent Application for a “Method of Detecting Physical Phenomena”, filed on Jun. 16, 2006, having application Ser. No. 60/804,990, which is incorporated herein by reference.

### BACKGROUND OF INVENTION

The present invention relates to improved methods of detecting physical phenomena and in particular, to detect substances that may be obscured by inactive or active spoofing methods, as well as naturally occurring phenomena.

In detecting contraband, there is a need for accurate detection of physical phenomena that may be weak, and hence have a signal that is only slight below the level of noise from the environment of the instrumentation itself.

Further, as spoof and jam may be used by someone attempting to hide or obscure contraband, by either masking the expected response from a detection method or providing a false signal of a non-suspicious nature, there is a need to make such detection methods jam and spoof proof.

General techniques for spoof and jam proofing are known in the military arts, such as for example U.S. Pat. No. 4,213,128 to Longinotti (issued Jul. 15, 1980), which pertains to a method for decreasing the jamming susceptibility of short range interrogators that is decreased using a time delay as a code means, to pulse jamming and spoofing. The technique uses information received prior to the time at which the earliest response would be expected as a measure of the jamming and spoofing density, and adjusts the sensitivity of the receiver to adapt to a high density situation.

A similar method is disclosed U.S. Pat. No. 4,837,575 to Conner, Jr. (issued Jun. 6, 1989) is for an identification system in which an interrogator produces two interrogation pulses, such as laser flashes, aimed at the target and separated from each other by a randomly determined period of time. The target detects the two interrogation pulses, measures elapsed time between the two pulses, and prepares a reply signal for transmission which is controlled by the elapsed time. Frequency, pulse width, and transmission delay parameters are each controlled in a substantially random, but predetermined manner in response to the elapsed time. The interrogator has a receiver and qualifier which receive reply signals and define expected values for the controlled parameters. An indication is provided concerning whether the target represents a friend or a foe based on received reply signals at the interrogator.

### SUMMARY OF INVENTION

In the present invention, the first object is achieved by providing a least one emitter and one detector, selecting at least a quasi-random sequence of times and durations for activating the emitter, activating the emitters at the selected sequence of times and durations, recording a response from the receiver at least during the sequence of times and duration during which the transmitters were activated, analyzing the recorded response for correlation with the time and durations of the emissions.

A second aspect of the invention is characterized in that there is provided at least one of an array of emitters or detectors, selecting at random a sequence of times and durations for activating the first and second emitters, activating the emitter(s) at the selected sequence of times and durations, recording a response form the one or more receivers at least during the sequence of times and duration during which the one or more emitters were activated, and analyzing the recorded response for correlation with the time and durations of the emissions.

In the present invention, another object is achieved by providing a least one emitter and one detector, selecting at least a quasi-random sequence of times and durations of different power levels emission for the emitter, activating the emitter at the selected sequence of times, durations and power levels, recording a response form the receiver at least during the sequence of times and duration during which the transmitters were activated, analyzing the recorded response for correlation with the time and durations of the emissions.

The above and other objects, effects, features, and advantages of the present invention will become more apparent from the following description of the embodiments thereof taken in conjunction with the accompanying drawings.

### BRIEF DESCRIPTION OF DRAWINGS

FIG. 1 is a schematic illustration of the application of the invention

FIG. 2 is a timing diagram relating to the apparatus and method shown in FIG. 1.

FIG. 3 is a timing diagram relating to the apparatus shown in FIG. 1 used in an alternative embodiment of the method of FIG. 2

FIG. 4 is a schematic illustration of the application of an alternative embodiment of the invention.

### DETAILED DESCRIPTION

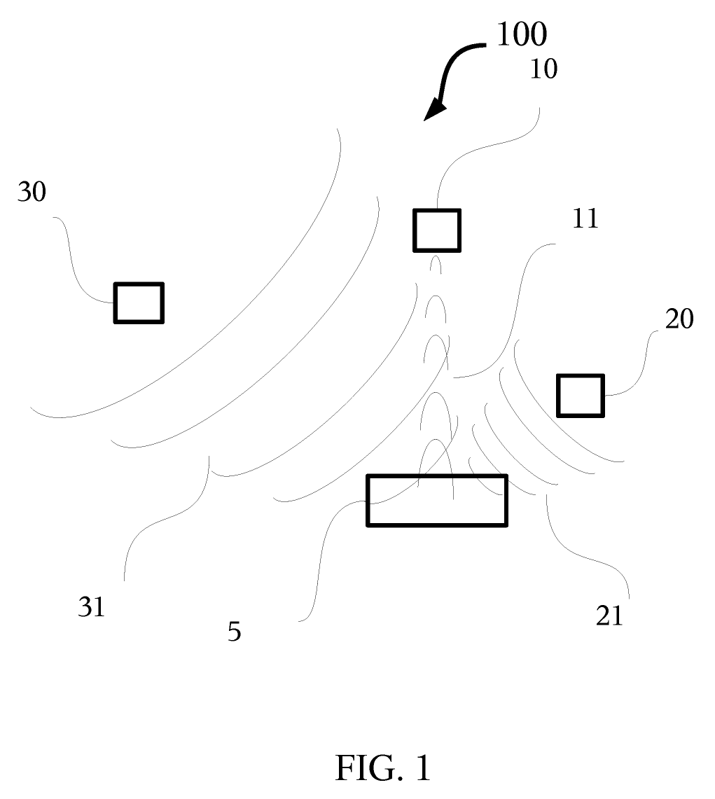

Referring to FIGS. 1 through 4, wherein like reference numerals refer to like components in the various views, there is illustrated therein a new and improved system and apparatus, generally denominated 100 herein, and method of detecting physical phenomena,

In accordance with the present invention, FIG. 1 illustrates a general operative principle wherein a detection system 100 comprising emitter 10 and at least one of detectors 20 and 30 is used to probe the nature and content of object 5, which may include the detection of its location as well as the chemical nature thereof.

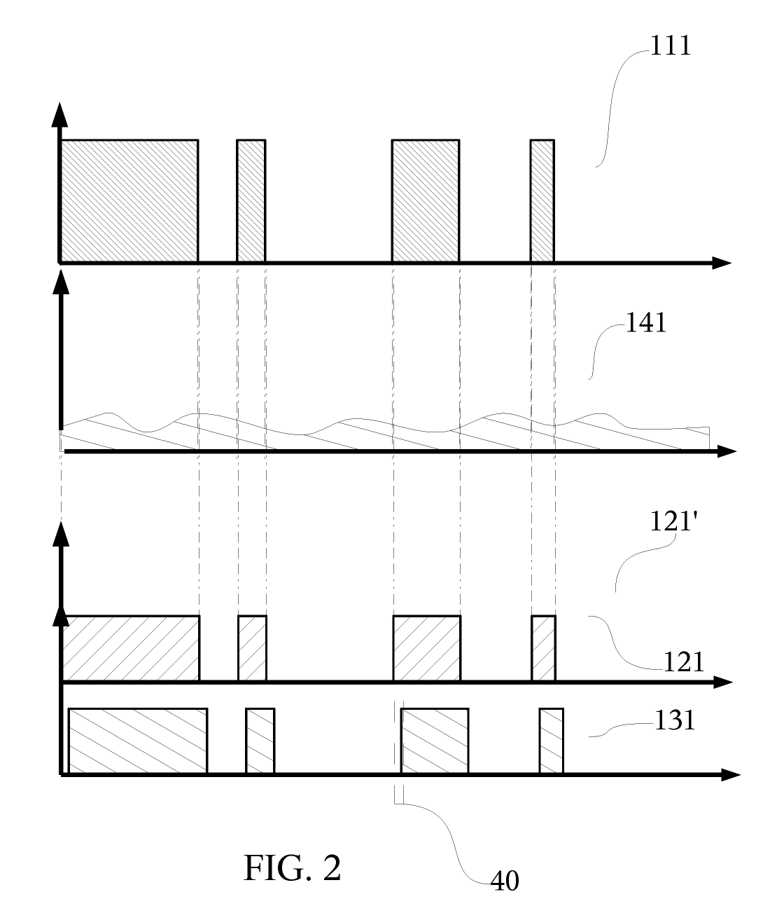

Emitter 10 illuminates suspected object 5 with a beam of radiation 11. According to a first embodiment of the invention a quasi-random pattern of pulses is generated to be sent by emitter 10. The timing diagram in FIG. 2 shows the temporal nature of radiation 11 as a quasi-random sequence of pulses that vary in duration as the sequence of shaded boxes, with the intervening gaps representing the timing or and spacing between pulse, the sequence being labeled 111. By quasi-random we mean either totally random, a random non-repeating sequence yet within predetermined upper and/or lower limits, or a repeating sequence which over some duration appears relatively random.

Detectors 20 detects radiation 21 emitted, scattered or reflected by the object 5, which may be the same or a different frequency than illuminating radiation 11. The temporal sequence of radiation received by detector 20 is labeled either 121, 121′ or 141 in FIG. 2. The temporal sequence of radiation 31 received by detector 30 is labeled 131 in the timing diagram.

The emitted radiation 21 or 31 is optionally the attenuated radiation from reflection, transmission, scattering and/or of the radiation, or in the case of re-transmission at another wavelength depending on the nature of object 5.

A true response 121 would vary in intensity according to the same timing sequence as the pulses 111, however a false or masking signal 121′ that merely is present to emit radiation of a nature that would simulate the characteristics of an alternative material would not have a modulated intensity, but the constant intensity illustrated. A background noise, which is received by at least of detector 20 and 30 is expected to have a lower and random signal intensity as shown by waveform 141.

Thus, in one alternative embodiments, an additional detector 30 detects radiation 31 emitted, scattered or reflected by the object 5, which may be the same or a different frequency than illuminating radiation 11. The temporal sequence of radiation 31 received by detector 30 is labeled either 131 in FIG. 2. It is expected that by placing detector 30 more distal from suspected object 5 than detector 20, their will be a time lag 40 between each detected pulse.

Further, depending on the nature and attention of the expected radiation 121, a potential difference in intensity may be observed at each pulse in 121 and 131.

When the time propagation characteristic, or distance dependent attenuation, of the expected radiation 121 are known it is possible to calculate the distance between the detected object 5 and each detector 20 and 30. Thus, by deploying a series or array of detectors around suspected object 5, it is possible to determine the actual position of the object or source 5 by triangulation from three of more detectors.

Examples forms of radiation 11 for illuminating the subject object 5 includes one ore more forms of radiation selected from UV, visible, near IR, IR or terahertz radiation, microwave or x-ray and the like, as well as known and future forms of spectroscopy. Terahertz radiation, that is in the frquency range of 1,000 GHz. and up, is non-ionizing and thus is not expected to damage DNA, unlike X-rays. Some frequencies of terahertz radiation can penetrate several centimeters of tissue and reflect back. Terahertz radiation can also detect differences in water content and density of a tissue. Some chemical compounds have unique absorption spectra over a range of terahertz freqencies. Because of terahertz radiation's ability to penetrate fabrics and plastics it can be used in surveillance, such as security screening, to uncover concealed weapons on a person, remotely. This is of particular interest because many materials of interest exhibit unique spectral fingerprints in the terahertz range. This offers the possibility of combining spectral identification with imaging.

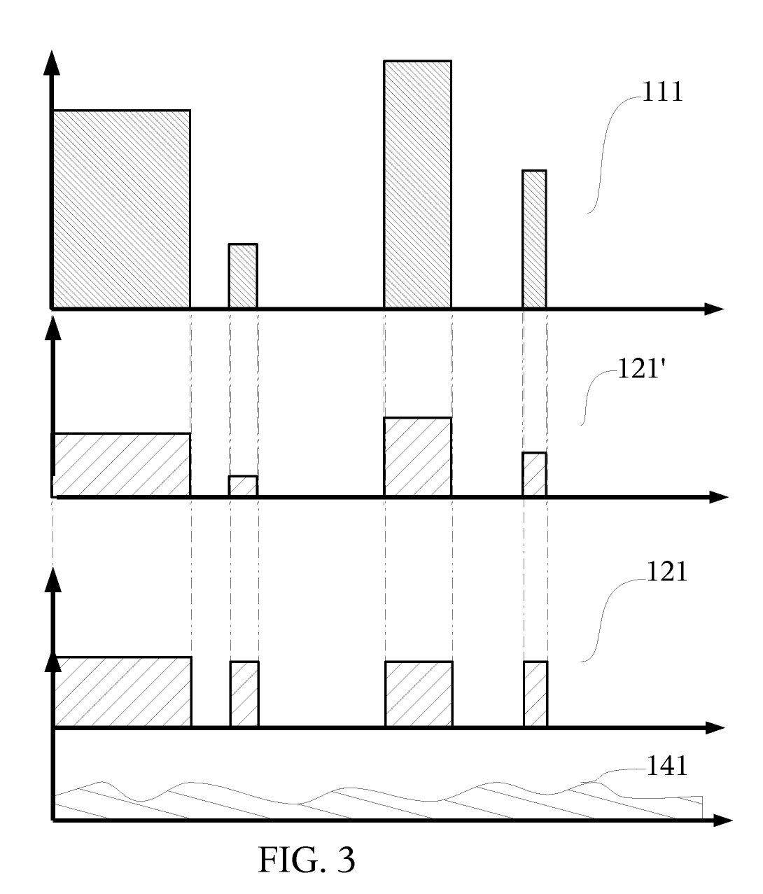

In an alternative embodiment of the invention, as illustrated by the timing diagram in FIG. 3, not only is the temporal nature of radiation 11 varied as a quasi-random sequence of pulses that variation in duration (the shaded boxes) and spacing, labeled 111, but the intensity or power of each pulse also varies in a quasi-random fashion.

A true response would vary in intensity according to the same timing sequence as shown in FIG. 3 as 121′, however a false signal that merely is able to detect the temporal nature of the radiation, and not able to modulate intensity would respond as 121′. A background noise is expected to have a lower and random signal intensity as shown by 141.

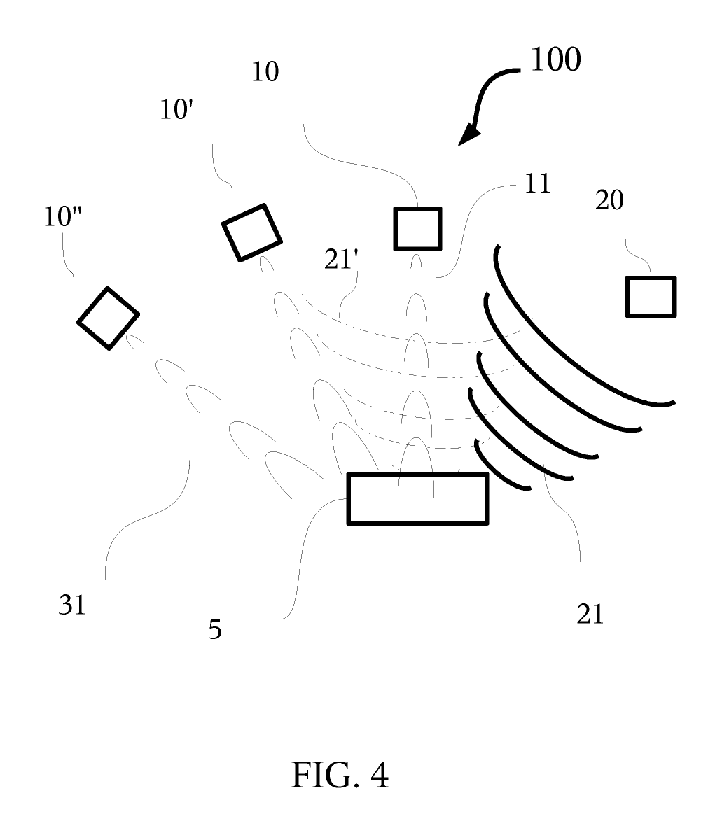

Other embodiments of the invention, of which a non-limiting example is provided by way of the illustration of FIG. 4, may include a second emitter 10′, or an array of emitter, that is 10, 10′ and 10″, and the like as illustrated.

It is expected, that depending on the nature of the expected or suspect object 5, as each of emitter 10, 10′, 10′ is disposed from object 5 with respect to detector 20 at least one of a different angular position or distance, depending on which emitter illuminates object 5, intensity, phase and direction of the emitted radiation 21 will vary accordingly. Therefore, detector 20 will record such variation. However, to the extent that object 5 or another source emits a false, jamming or spoof signal, shown as radiation 21′, the detector 20 would record a constant signal.

In the more preferred embodiments, actual sampling by the detector(s) is specifically when the system is operative to cause the interaction of the radiation with the object by a specific physical phenomenon. Accordingly, it is difficult to fake the existence of a specific measurable physical phenomenon when the measurement is related to the detector reading itself so that noise can be ignored.

Other embodiments of the invention include in a first step of sending signals in a quasi-random sequence from at least one or a plurality of emitters to stimulate a response from the environment. As a second step at least one or a plurality of detectors or receivers are activated to record the signals in coordination with the detecting of the response with a plurality of receivers when the quasi-random sequence of signals is sent. In such embodiments of the invention there is communication between a command means that activates or programs the transmitters/emitters and activate the receiver/detectors to measure or record the sequence. Other aspects and embodiments include analysis and comparison of the nature and changes in the timing, amplitude, phase or frequency of the detected signal is coordinated with the timing, amplitude, phase or frequency of the one or more emitters output. When such changes are detected through the systems' operations, the user is alerted to the fact that there is either noise or some sort of fake signal or spoofing.

It should be appreciated that in the aforementioned embodiments all or any of the transmitters and receivers can be the same type, but at dispersed locations. Further, the transmitters and receivers can be set to detect different wavelength or frequencies of radiation, or be broadband receivers with wavelength discrimination capability.

While the invention has been described in connection with a preferred embodiment, it is not intended to limit the scope of the invention to the particular form set forth, but on the contrary, it is intended to cover such alternatives, modifications, and equivalents as may be within the spirit and scope of the invention as defined by the appended claims.

1. A process to eliminate the spoofing of physical phenomena, the process comprising the steps of:
a) providing at least a first transmitter,
b) providing one or more receivers in an array,
c) selecting a sequence for activating the first and second transmitters,
d) activating the transmitters at the selected sequence,
e) recording a response from the receivers at least during the sequence during which the transmitters were activated,
f) analyzing the recorded response for correlation with the time and durations of the emissions.

2. A process according to claim 1 wherein said step of analyzing further comprising the steps of:
a) providing a second transmitter to form an array of at least two transmitters, and
b) determining the spatial location of the source of any apparent response.

3. A process according to claim 2 wherein the transmitters are activated in at least one of a random and quasi-random sequence.

4. A process according to claim 1 wherein the transmitters are activated in at least one of a random and quasi-random sequence.

5. A process according to claim 4 wherein the random or quasi-random sequence is a variation of at least one of the time, time interval, amplitude, phase and frequency of the emission.

6. A process according to claim 5 wherein during the random or quasi-random sequence the detection of the signal is coordinated with the output sequence of the one or more transmitters.

7. A process according to claim 2 wherein each of two or more transmitters are disposed at an angular separation from an object to be analyzed.

8. A process according to claim 7 wherein said step of analyzing further comprises the step of determining the spatial location of the source of any apparent response.

9. A process according to claim 1 wherein the transmitters can transmit different wavelengths or frequencies of radiation

10. A process according to claim 9 wherein the receivers can detect different wavelength or frequencies of radiation.

11. A process according to claim 1 wherein the receivers are broadband receivers with wavelength discrimination capability.

12. A process according to claim 1 wherein the receivers can detect terahertz radiation.

13. A process according to claim 9 wherein the receivers can detect terahertz radiation.
